(19) United States
(12) Patent Application Publication
(10) Pub. No.: US 2026/0264152 A1
(43) Pub. Date: Sep. 10, 2026

(54) INDEXABLE CUTTING TOOL INSERTS AND METHODS OF USING INDEXABLE CUTTING TOOL INSERTS

(71) Applicant: GREENLEAF TECHNOLOGY CORPORATION, Saegertown, PA (US)

(72) Inventors: Donald R. Hughes, Meadville, PA (US); Melanie Ann Peterman, Conneautville, PA (US); Martin J. Dillaman, Meadville, PA (US)

(21) Appl. No.: 19/372,646

(22) Filed: Oct. 29, 2025

Related U.S. Application Data
(60) Provisional application No. 63/766,544, filed on Mar. 4, 2025.

(51) Int. Cl. B23B 27/16

(52) U.S. Cl. CPC B23B 27/1611

(57) ABSTRACT

A cutting tool insert comprises a first end including a generally circular periphery defining at least two arcuate cutting edge regions; a second end; and an elongate portion. The elongate portion includes a mounting region including a plurality of substantially flat side regions capable to be received in an insert pocket of a tool holder and defining at least two indexing orientations of the cutting tool insert as installed in the insert pocket of the tool holder. The elongate portion further includes an inverted frustoconical shaped clearance region extending along a second portion of the longitudinal axis to the circular periphery of the first end, wherein each arcuate cutting edge region of the circular periphery is associated with one of the at least two indexing orientations.

### CROSS-REFERENCE TO RELATED APPLICATIONS

This application claims the benefit of U.S. Provisional Patent Application No. 63/766,544, filed Mar. 4, 2025, the entire disclosure of which is hereby incorporated herein by reference.

### FIELD

This disclosure relates generally to indexable cutting tool inserts and methods of using indexable cutting tool inserts.

### BACKGROUND

After a first cutting edge region of an indexable cutting tool insert has worn or is damaged, the insert can be indexed to provide a new cutting edge region. Indexing the cutting tool insert typically requires unsecuring the insert from the insert pocket, reorienting the insert in the pocket, and re-securing the insert in the pocket, so that a fresh cutting edge region is disposed to contact a workpiece during machining. The cutting tool insert must be accurately positioned and stably secured within the insert pocket or forces imparted to the cutting tool insert during machining operations may cause the insert to rotate or otherwise shift relative to the tool holder. There are challenges with accurately positioning and stably securing an indexable cutting tool insert to a tool holder.

### SUMMARY

One aspect of the present disclosure is directed to a cutting tool insert. The cutting tool insert comprises a first end, a second end, and an elongate portion. The first end comprises a generally circular periphery. The generally circular periphery defines at least two arcuate cutting edge regions. The elongate portion extends from the first end to the second end along a longitudinal axis of the cutting tool insert. The elongate portion comprises a mounting region and an inverted frustoconical shaped clearance region. The mounting region extends along a first portion of the longitudinal axis to the second end. The mounting region comprises a plurality of substantially flat side regions capable to be received and positioned in an insert pocket of a tool holder and defining at least two indexing orientations of the cutting tool insert as installed in the insert pocket of the tool holder. The inverted frustoconical shaped clearance region extends along a second portion of the longitudinal axis to the generally circular periphery of the first end. Each arcuate cutting edge region of the generally circular periphery is associated with one of the at least two indexing orientations.

Another aspect of the present disclosure is directed to a machining method. The method comprises removing material from a workpiece with at least one cutting tool insert secured to a tool holder of a machine tool. The cutting tool insert comprises a first end, a second end, and an elongate portion. The first end includes a generally circular periphery. The generally circular periphery defines at least two arcuate cutting edge regions. The elongate portion extends from the first end to the second end along a longitudinal axis of the cutting tool insert. The elongate portion comprises a mounting region and an inverted frustoconical shaped clearance region. The mounting region extends along a first portion of the longitudinal axis to the second end. The mounting region comprises a plurality of substantially flat side regions capable to be received in an insert pocket of a tool holder and defining at least two indexing orientations of the cutting tool insert as installed in the insert pocket of the tool holder. The inverted frustoconical shaped clearance region extends along a second portion of the longitudinal axis to the generally circular periphery of the first end. Each arcuate cutting edge region of the generally circular periphery is associated with one of the at least two indexing orientations. When an arcuate cutting edge region removing material from the workpiece has worn or becomes damaged, the cutting tool insert may be repositioned in the insert pocket to a different indexing orientation, presenting a fresh arcuate cutting edge region to the workpiece during machining.

An additional aspect of the present disclosure is directed to a tool holder including at least one replaceable cutting tool insert according to the present disclosure. The cutting tool insert comprises a first end, a second end, and an elongate portion. The first end comprises a generally circular periphery. The generally circular periphery defines at least two arcuate cutting edge regions. The elongate portion extends from the first end to the second end along a longitudinal axis of the cutting tool insert. The elongate portion comprises a mounting region and an inverted frustoconical shaped clearance region. The mounting region extends along a first portion of the longitudinal axis to the second end. The mounting region comprises a plurality of substantially flat side regions capable to be received and positioned in an insert pocket of a tool holder and defining at least two indexing orientations of the cutting tool insert as installed in the insert pocket of the tool holder. The inverted frustoconical shaped clearance region extends along a second portion of the longitudinal axis to the generally circular periphery of the first end. Each arcuate cutting edge region of the generally circular periphery is associated with one of the at least two indexing orientations. In various embodiments, the tool holder is a cutting tool selected from a face mill, an end mill, a turning (lathe) tool, a boring tool, a grooving tool, a parting tool, a blisk milling cutter, a slotting cutter, and a threading tool.

Although the present disclosure relates to different aspects and embodiments, it is understood that the different aspects and embodiments disclosed herein can be integrated, combined, or used together as a combination system or apparatus, or in part, as separate components, systems, or apparatus, as appropriate. Thus, each embodiment disclosed herein can be incorporated in each of the aspects to varying degrees as appropriate for a given implementation.

These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a perspective view of a non-limiting embodiment of an indexable cutting tool insert according to the present disclosure;

FIG. 2 is a perspective view of a non-limiting embodiment of an indexable cutting tool insert according to the present disclosure;

FIG. 3 is a perspective view of a non-limiting embodiment of an indexable cutting tool insert according to the present disclosure;

FIG. 4 is a perspective view of a non-limiting embodiment of an indexable cutting tool insert according to the present disclosure;

FIG. 5 is a side view of a non-limiting embodiment of an indexable cutting tool insert according to the present disclosure;

FIG. 6A is a top view of a non-limiting embodiment of an indexable cutting tool insert according to the present disclosure;

FIG. 6B is an exploded perspective view of a non-limiting embodiment of a cutting tool including an embodiment of an indexable cutting tool insert according to the present disclosure;

FIG. 7 is a side view of a non-limiting embodiment of an indexable cutting tool insert according to the present disclosure;

FIG. 8A is a top view of a non-limiting embodiment of an indexable cutting tool insert according to the present disclosure;

FIG. 8B is a perspective view of a non-limiting embodiment of a cutting tool including an embodiment of an indexable cutting tool insert according to the present disclosure;

FIG. 9 is a flow chart of a non-limiting embodiment of an machining method according to the present disclosure;

FIG. 10 is a perspective view of a non-limiting embodiment of an indexable cutting tool insert according to the present disclosure;

FIG. 11 is a perspective view of a non-limiting embodiment of an indexable cutting tool insert according to the present disclosure;

FIG. 12 is a perspective partial assembly view of a non-limiting embodiment of a face milling cutter according to the present disclosure;

FIG. 13 is a perspective assembly view of a non-limiting embodiment of a tool holder according to the present disclosure;

FIG. 14A is a perspective partial assembly view of a non-limiting embodiment of a blisk milling cutter according to the present disclosure; and

FIG. 14B is perspective view of an insert pocket of the blisk milling cutter of FIG. 14A.

### DETAILED DESCRIPTION OF CERTAIN EMBODIMENTS

V-bottom round cutting tool inserts used in various machining operations may provide two cutting edge indexing orientations. When such cutting tool inserts are positioned and secured in the insert pocket of a tool holder, a first cutting edge region is disposed so as to contact the workpiece during machining. The first cutting edge region spans generally one-half of the circumference of the cutting tool insert's round top surface. Although the first cutting edge region may be considered to span 180 degrees of the top surface's round circumference, the actual region of contact between the first cutting edge region and the workpiece may be less than 180 degrees. After the first cutting edge region has worn or is damaged during machining, the cutting tool insert can be unsecured from the insert pocket, rotated or otherwise repositioned (i.e., indexed) in the insert pocket, and re-secured in the pocket so that a second region of the cutting edge defined by the top surface's circumference is presented to and machines the workpiece. The second cutting edge region spans generally the remaining one-half (180 degrees) of the circumference of the cutting tool insert's round top surface, although the actual region of contact between the second cutting edge region and the workpiece during the machining operation may be less than 180 degrees.

Certain machining operations, such as, for example, slot milling and trochoidal turning, utilize a majority of the 180-degree cutting edge of two-sided indexable round cutting tool insert. As suggested above, however, other machining operations may require lighter turning and facing cuts and may utilize only a portion of the 180-degrees of the cutting edge region.

Designing round cutting tool inserts to provide more than two indexing orientations can increase the life of the cutting tool insert, lengthening the time before cutting tool insert replacement and increasing machining efficiency. Also, providing a round cutting tool insert with a geometry that can enhance stability of the insert in the insert pocket during machining can reduce the likelihood that the insert shifts position (e.g., rotates and/or tilts) in the insert pocket during machining, thereby improving results of the machining operation. Enhancing stability of round cutting tool inserts in the insert pocket during machining can be particularly important if the insert is designed to allow for more than two indexing orientations given the size and proximity of the individual cutting edge regions about the circumference of the insert's top surface.

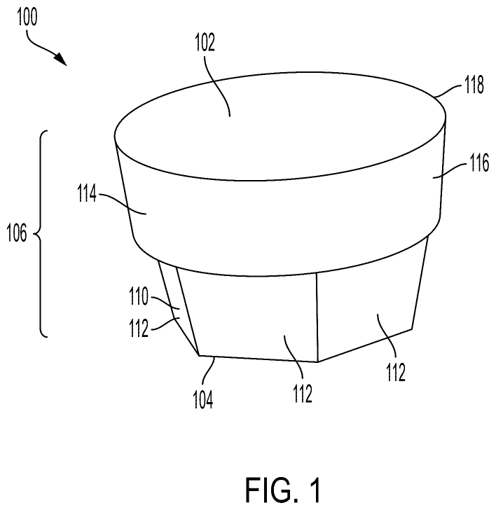

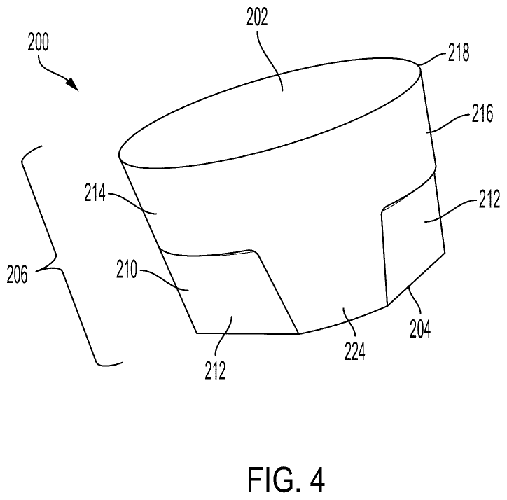

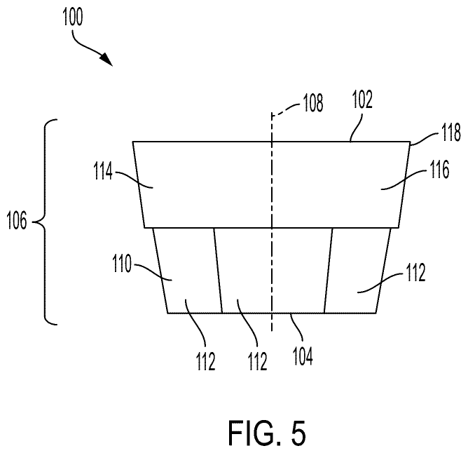

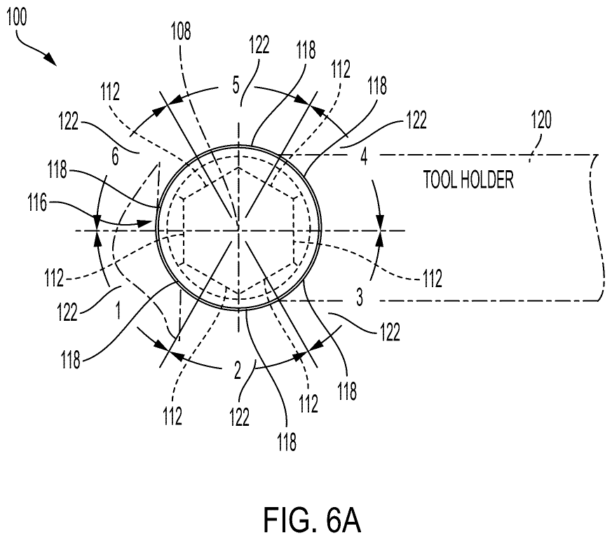

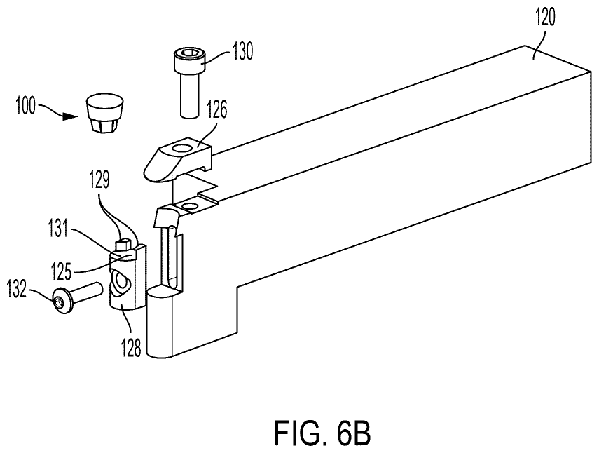

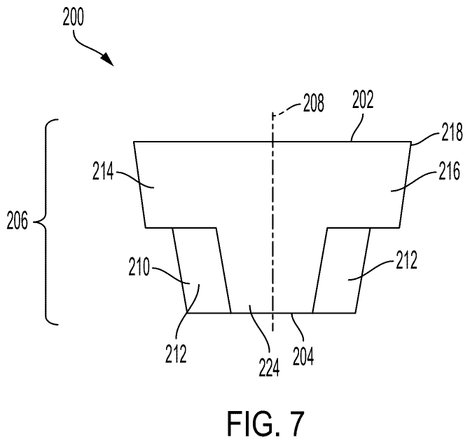

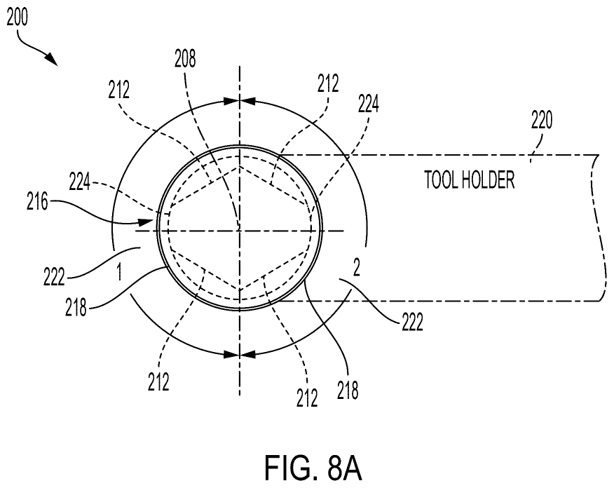

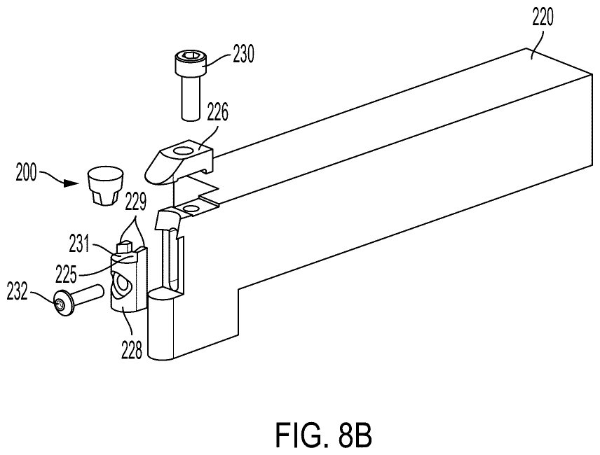

The present disclosure provides indexable cutting tool inserts and methods of using the cutting tool inserts. The cutting tool inserts' geometries can improve stability of the inserts in the insert pocket of a tool holder or other machine tool. Certain embodiments of the cutting tool inserts according to the present disclosure include more than two indexing orientations, which can increase service life. Aspects of certain non-limiting embodiments of cutting tool inserts according to the present invention are shown schematically in accompanying FIGS. 1 through 8B. FIGS. 1-3, 5, and 6A-6B illustrate aspects of a first embodiment of a cutting tool insert 100 according to the present disclosure. As discussed below, and as shown in FIG. 6A, cutting tool insert 100 provides six indexing orientations 122 so that, when the cutting tool insert 100 is positioned within an insert pocket 125 of a tool holder 120, one of six cutting edge regions 118 is disposed so as to contact and machine a workpiece. FIGS. 4, 7, and 8A-8B illustrate aspects of a second embodiment of a cutting tool insert 200 according to the present disclosure. As discussed below, and as shown in FIG. 8A, cutting tool insert 200 provides two indexing orientations 222 so that, when cutting tool insert 200 is positioned within an insert pocket 225 of a tool holder 220, one of the two cutting edge regions 218 is disposed so as to contact and machine a workpiece.

In the arrangements shown in FIGS. 6B and 8B, respectively, insert pockets 125, 225 are specially configured regions of nest members 128, 228 which can be removed from the tool holders 120, 220. However, as will be apparent on consideration of the present description and the accompanying figures, in various alternative non-limiting embodiments, cutting tool inserts according to the present disclosure may be secured in fixed insert pockets which are not regions of a removable nest member and cannot be removed from other elements of the tool holder. For example, insert pockets machined directly into a tool holder can be configured to receive cutting tool inserts having a geometry according to the present disclosure.

Although reference is made herein to a “tool holder” and a simplified tool holder is depicted in certain of the accompanying figures, it will be understood that the cutting tool inserts according to the present disclosure can be secured to any tool holder or cutting tool (e.g., an endmill, a face mill, a boring tool, a grooving tool) comprising an insert pocket suitably configured to receive a cutting tool insert have a geometry according to the present disclosure. Thus, the term “tool holder” is used herein to refer broadly to any holder, tool, cutter, etc., that has been adapted or designed to receive at least one replaceable cutting tool insert having the unique design according to the present disclosure. Non-limiting examples of tool holders include face mills, end mills, turning (lathe) tools, boring tools, grooving and parting tools, blisk milling cutters and other types of slotting cutters, and threading tools.

The cutting tool inserts 100, 200 can have a unitary, one-piece construction and can comprise any material suitable for use in cutting tool inserts. Such materials include, for example, carbides, cermets, cubic boron nitride, and ceramics, including whisker-reinforced ceramics. In certain non-limiting embodiments, for example, cutting tool inserts 100, 200 can be made from any of the WG-300®, WG-600®, and WG-700™ whisker-reinforced ceramic materials available from Greenleaf Corporation, Saegertown, Pennsylvania USA.

As shown in FIGS. 6A-6B and 8A-8B, respectively, cutting tool inserts 100, 200 are removably securable to a tool holder 120, 220. Once secured to the tool holder 120, 220, the suitably oriented cutting edge region 118, 218 of the cutting tool insert 100, 200 can contact and machine a workpiece during a machining operation. As the exposed cutting edge region 118, 218 wears or is damaged, the cutting tool insert 100, 200 can be rotated or otherwise reoriented to assume a new indexing orientation 122, 212 in the insert pocket of the 125, 225, thereby presenting a fresh cutting edge region 118, 218 to contact the workpiece during machining.

Referring to FIGS. 1-3, 5, 6A-B, cutting tool insert 100 comprises a first end 102, a second end 104, and an elongate portion 106 extending from the first end 102 to the second end 104 along a longitudinal axis 108 of the cutting tool insert 100. The first end 102 defines a circular periphery 116 delimiting six arcuate cutting edge regions 118. The length of the arcuate cutting edge regions 118 can vary based on the length of the circumference of the circular periphery 116. Also, although cutting tool insert 100 is illustrated with a circular periphery 116, some variation from circular may be utilized in certain embodiments, e.g., ovular or elliptical, which can result in certain of the cutting edge regions 118 being longer than certain other of the cutting edge regions.

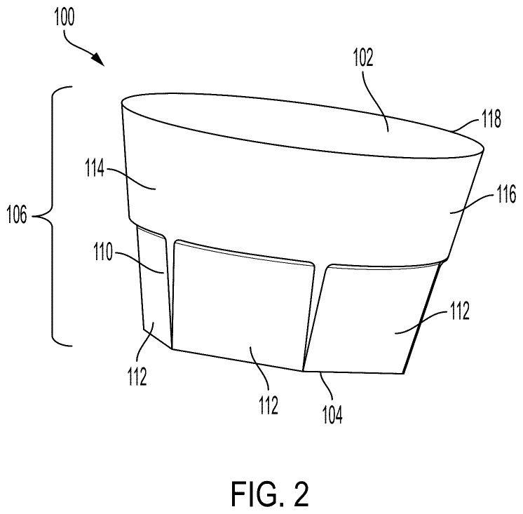

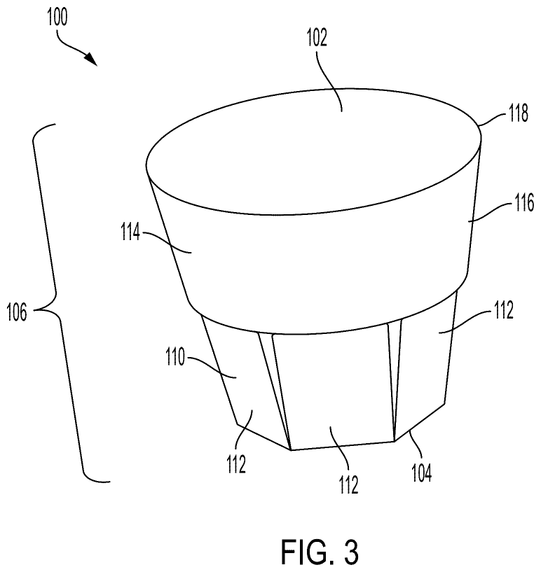

Again referring to FIGS. 1-3, 5, and 6A-B, the elongate portion 106 comprises a mounting region 110 and a clearance region 114 disposed along the longitudinal axis 108 of the cutting tool insert 100. In various embodiments, the elongate portion 106 can define a longitudinal axial length of the cutting tool insert 100 with respect to the longitudinal axis 108. The longitudinal axial length of the cutting tool insert 100 can vary depending on the machining operation and/or tool holder for which the cutting tool insert 100 is designed. For example, a cutting tool insert 100 with a relatively long longitudinal axial length, such as illustrated in FIG. 3, can be adapted for rough, large scale machining operations. As another example, a cutting tool insert 100 with a relatively short longitudinal axial length, such as illustrated in FIG. 2, can be adapted for lighter, small scale machining operations. The longitudinal axial length of the cutting tool insert 100 may be any suitable longitudinal axial length capable of being secured within the insert pocket 125 of the tool holder 120.

The mounting region 110 can extend along a first portion of the longitudinal axis 108 to the second end 104. The mounting region 110 can extend an axial distance along the longitudinal axis 108 relative to the axial length of the cutting tool insert. For example, the mounting region 110 can extend an axial distance of at least 50% of the overall longitudinal axial length of the cutting tool insert, such as, for example, at least 60%, at least 70%, or at least 80% of the overall longitudinal axial length of the cutting tool insert 100. As another example, the mounting region 110 can extend an axial distance less than 50% of the overall longitudinal axial length of the cutting tool insert, such as, for example, less than 40%, less than 30%, or less than 20% of the overall longitudinal axial length of the cutting tool insert 100.

In various embodiments, the clearance region 114 can be an inverted frustoconical shaped region. As will be understood, “frustoconical” refers to an object or shape having the form of a frustum of a cone. Also, an “inverted” frustoconical shape is one in which the wider transverse cross section of the shape is at the top of the shape. An example of an inverted frustoconical shape is an upside down frustum of a cone, which has a side surface tapering inwardly from the top to the bottom of the shape.

The clearance region 114 can extend along a second portion of the longitudinal axis 108 to the circular periphery 116 of the first end 102. The clearance region 114 can extend an axial distance along the longitudinal axis 108 relative to the axial length of the cutting tool insert 100, such that the clearance region 114 intersects with a planar surface bounded by the circular periphery 116 of the first end 102 to form the indexable cutting edge regions 118. For example, the distance the clearance region 114 extends along the second portion of the longitudinal axis 108 can be less than the distance the mounting region 110 extends along the second portion of the longitudinal axis 108. As another example, the distance the clearance region 114 extends along the second portion of the longitudinal axis 108 can be greater than the distance the mounting region 110 extends along the first portion of the longitudinal axis 108. In various embodiments, the distance the clearance region 114 extends along the second portion of the longitudinal axis 108 is equal to the distance the mounting region 110 extends along the first portion of the longitudinal axis 108.

The clearance region 114 can comprise a side clearance angle defined between a plane including the circular periphery 116 of the first end 102 and a line along a surface of the clearance region 118 coplanar with the longitudinal axis 108. The side clearance angle can be in a range of 0 to 20 degrees, such as, for example, 0 to 15 degrees, 0 to 10 degrees, 6 to 20 degrees, 7 to 15 degrees, 7 to 11 degrees, or 8 to 10 degrees. In various embodiments, the side clearance angle may be about 7 degrees or about 11 degrees.

The side clearance angle may be consistent or may vary along the clearance region 114. For example, the side clearance angle may be a first side clearance angle along a first portion of the clearance region 114, and may be a second side clearance angle, differing from the first side clearance angle, along a second portion of the clearance region 114. Variable side clearance angles along the clearance region 114 may be beneficial to reduce tool pressure and improve machining performance. In addition, varying the side clearance angle along the clearance region may be favorable in select applications such as slot/blisk milling and/or trochoidal turning.

In an alternative non-limiting embodiment shown in FIGS. 4, 7, and 8A-8B, cutting tool insert 200 comprises a first end 202, a second end 204, and an elongate portion 206 extending from the first end 202 to the second end 204 along a longitudinal axis 208 of the cutting tool insert 200. The first end 202 defines a circular periphery 216 delimiting two arcuate cutting edge regions 218. The length of the arcuate cutting edge regions 218 can vary based on the length of the circumference of the circular periphery 216. Also, although cutting tool insert 200 is illustrated with a circular periphery 216, variations from circular may be utilized in certain embodiments, e.g., ovular or elliptical.

With further reference to FIGS. 4, 7, and 8A-8B, the elongate portion 206 comprises at least a mounting region 210 and a clearance region 214 disposed along the longitudinal axis 208 of the cutting tool insert 200. The elongate portion 206 can define an axial length of the cutting tool insert 200 with respect to the longitudinal axis 208. The axial length of the cutting tool insert 200 can vary depending on the machining operation and/or tool holder for which the cutting tool insert 100 is designed. For example, a cutting tool insert 200 with a relatively long axial length can be adapted for rough, large scale machining operations. As another example, a cutting tool insert 200 with a relatively short axial length can be adapted for lighter, small scale machining operations. The axial length of the cutting tool insert 200 may be any suitable axial length capable of being secured within the insert pocket 225 of the tool holder 220.

The mounting region 210 can extend along a first portion of the longitudinal axis 208 to the second end 204. The mounting region 210 can extend an axial distance along the longitudinal axis 208 relative to the axial length of the cutting tool insert. For example, the mounting region 210 can extend an axial distance of at least 50% of the overall axial length of the cutting tool insert, such as, for example, at least 60%, at least 70%, or at least 80% of the overall axial length of the cutting tool insert 200. As another example, the mounting region 210 can extend an axial distance less than 50% of the overall axial length of the cutting tool insert, such as, for example, less than 40%, less than 30%, or less than 20% of the overall axial length of the cutting tool insert 200.

In various embodiments, the clearance region 214 can be an inverted frustoconical shaped region. The clearance region 214 can extend along a second portion of the longitudinal axis 208 to the circular periphery 116 of the first end 102. The clearance region 214 can extend an axial distance along the longitudinal axis 208 relative to the axial length of the cutting tool insert 200, such that the clearance region 214 intersects with a planar surface bounded by the circular periphery 216 of the first end 202 to form the indexable cutting edge regions 218. For example, the distance the clearance region 214 extends along the second portion of the longitudinal axis 208 can be less than the distance the mounting region 220 extends along the second portion of the longitudinal axis 208. As another example, the distance the clearance region 214 extends along the second portion of the longitudinal axis 208 can be greater than the distance the mounting region 210 extends along the first portion of the longitudinal axis 208. In various embodiments, the distance the clearance region 214 extends along the second portion of the longitudinal axis 208 is equal to the distance the mounting region 210 extends along the first portion of the longitudinal axis 208.

The clearance region 214 can comprise a side clearance angle defined between a plane including the circular periphery 216 of the first end 202 and a line along a surface of the clearance region 218 coplanar with the longitudinal axis 208. The side clearance angle can be in a range of 0 to 20 degrees, such as, for example, 0 to 15 degrees, 0 to 10 degrees, 6 to 20 degrees, 7 to 15 degrees, 7 to 11 degrees, or 8 to 10 degrees. In various embodiments, the side clearance angle may be about 7 degrees or about 11 degree.

The side clearance angle may be consistent along the clearance region 214, or it may vary along the clearance region 214. For example, the side clearance angle may be a first side clearance angle along a first portion of the clearance region 214, and may be a second side clearance angle, differing from the first side clearance angle, along a second portion of the clearance region 214. Variable side clearance angles along the clearance region 214 may be beneficial to reduce tool pressure and improve machining performance.

With reference to FIGS. 1-3, 5, and 6A showing cutting tool insert 100, in various embodiments the mounting region 110 of insert 100 may take the general form of a frustum of a multi-sided pyramid. As specifically shown in FIGS. 1-3 and 5, the mounting region 110 of cutting tool insert 100 has the form of a frustrum of a six-sided pyramid, configuring the cutting tool insert 100 to allow for six indexing orientations, i.e., as a “six-sided” indexable round cutting tool insert.

With reference to FIGS. 4, 7, and 8A showing cutting tool insert 200, in various embodiments the mounting region 210 of insert 200 may take the form of a frustum of a pyramid combined with a frustum of a cone, configuring the cutting tool insert 200 to allow for two indexing orientations, i.e., as a “two-sided” indexable round cutting tool insert.

With respect to cutting tool inserts 100 and 200, respectively, the mounting regions 110, 201 can comprise a plurality of (i.e., at least two) substantially flat side regions 112, 212.

The plurality of substantially flat side regions 112, 212 are capable to be received in an insert pocket 125, 225 of a tool holder 120, 220. As illustrated in FIG. 6A, the plurality of substantially flat sides regions 112 of cutting tool insert 100 can define six indexing orientations 122 of the cutting tool insert 100 as selectively oriented and secured in the insert pocket 125 of the tool holder 120. As illustrated in FIG. 8A, the plurality of substantially flat sides 212 of cutting tool insert 200 can define two indexing orientations 222 of the cutting tool insert 200 as selectively oriented and secured in the insert pocket 225 of the tool holder 220.

Each arcuate cutting edge region 118, 225 of the circular periphery 116, 216 of cutting tool inserts 100, 200, respectively, is associated with one of multiple (i.e., two or more) indexing orientations 122, 222. The cutting tool insert 100, 200 can be disposed within an insert pocket 125, 225 of the tool holder 120, 220 in an indexing orientation 122, 222 such that one of cutting edge regions 118, 228 is disposed relative to the tool holder to contact a workpiece during machining operations.

For example, with reference to FIG. 6A, when cutting tool insert 100 is secured in the insert pocket 125 of the tool holder 120 in a first one of the multiple indexing orientations 122, a first one of the six cutting edge regions 118 indicated by numerals “1” to “6” can be disposed to contact the workpiece being machined. Once the first one of the six cutting edge regions 118 has worn or is damaged, the cutting tool insert 100 can be unsecured from the insert pocket 125, rotated, and resecured in the insert pocket 125 in a second indexing orientation 122, thereby positioning an unused, second one of the six cutting edge regions 118 to contact the workpiece during the machining operation. The rotational repositioning of the cutting tool insert 100 relative to the tool holder 120 among the six indexing orientations is indicated by the arcuate arrows.

Also, for example, with reference to FIG. 8A, when cutting tool insert 200 is secured in the insert pocket 225 of the tool holder 220 in a first one of the two indexing orientations 222, a first one of the two cutting edge regions 218 indicated by numerals “1” an “2” can be disposed to contact the workpiece being machined. Once the first one of the two cutting edge regions 218 has worn or is damaged, the cutting tool insert 200 can be unsecured from the insert pocket 225, rotated, and re-secured in the insert pocket 225 in a second one of the two indexing orientations 222, thereby positioning an unused, second one of the two cutting edge regions 218 to contact the workpiece during the machining operation. The rotational repositioning of the cutting tool insert 200 relative to the tool holder 220 between the two indexing orientations is indicated by the arcuate arrows.

The number of indexing orientations 122, 222 and the number of corresponding cutting edge regions 118, 218 correspond to the number of times the cutting tool insert 100, 200 may be reoriented (e.g., rotated) in the insert pocket 125, 225 of the tool holder 120, 220 before the cutting tool insert 100, 200 is fully worn and needs to be replaced with a fresh cutting tool insert.

For example, as illustrated in FIGS. 1-3, 5, and 6A, the plurality of substantially flat side regions 112 may define six indexing orientations 122 of the cutting tool insert 100 as secured in the insert pocket 125 of the tool holder 120. The six indexing orientations 122 of the cutting tool insert 100 may result from the six substantially flat sides 112 of the mounting region 110 of the cutting tool insert 100. The six substantially flat side regions 112 may be distributed about the mounting region 110 around the longitudinal axis 108 to define a hexagonal transverse cross-section of the mounting region 110. Each of the six substantially flat sides 112 may be symmetrically arranged around the circumference of the mounting region 110, such that each of the six substantially flat sides 112 is separated by an angle of approximately 60 degrees and each of the six cutting edge regions 118 includes up to 60 degrees of the circumference of the circular periphery 116.

As another example, illustrated in FIGS. 4, 7, and 8A, the plurality of substantially flat side regions 212 may define two indexing orientations 222 of the cutting tool insert 200 as installed in the insert pocket 225 of the tool holder 220. The two indexing orientations 222 of the cutting tool insert 200 may result from the four substantially flat side regions 212. For example, a transverse cross-section of the mounting region can comprise two oppositely disposed V-shaped, flat sides 212, between which are curved regions 224. As such, the mounting region 210 may comprise first and second curved side regions 224, a first substantially flat side region 212 positioned adjacent to a second substantially flat side region 212, and a third substantially flat side region 212 positioned adjacent to a fourth substantially flat side region 212, wherein a first curved side region 224 is intermediate the first and the third substantially flat side regions 212, and a second curved side region 224 is intermediate the second and the fourth substantially flat side regions 212. The two curved regions 224 and the four substantially flat sides 212 may be symmetrically distributed around the circumference of the mounting region 210, such that each of two cutting edge regions 218 may include up to 180 degrees of the circumference of the circular periphery 116.

As illustrated in FIGS. 6A-6B with respect to cutting tool insert 100, the plurality of substantially flat sides 112 are capable of nesting on the insert pocket 125 of a removable nest member 128 of the tool holder 120. The substantially flat side regions 112 of the mounting region 110 can contact elements of the insert pocket 125 to provide a secure and stable attachment when the nest member 128 is secured to the tool holder 120 and the cutting tool insert 100 is mounted in the insert pocket 125 of the nest member 128, thereby stabilizing and inhibiting the cutting tool insert 100 from moving (e.g., rotating, tilting, and/or sliding) in the insert pocket 125 during machining.

Similarly, as illustrated in FIGS. 8A-8B with respect to cutting tool insert 200, the plurality of substantially flat sides 212 are capable of nesting on the insert pocket 225 of a removable nest member 228 of the tool holder 220. The substantially flat side regions 212 of the mounting region 210 can contact elements of the insert pocket 225 to provide a secure and stable attachment when the nest member 228 is secured to the tool holder 220 and the cutting tool insert 200 is mounted in the insert pocket 225 of the nest member 228, thereby stabilizing and inhibiting the cutting tool insert 200 from moving (e.g., rotating, tilting, and/or sliding) in the insert pocket 225 during machining.

In various embodiments, the width of the substantially flat sides 112, 212 of the cutting tool inserts 100, 200, respectively, can be increased, to increase the overall surface area of each of the substantially flat sides 112, 212. Increasing the surface area of the substantially flat sides 112, 212 may improve stability of the cutting tool insert 100, 200 in the insert pocket 125, 225 of the tool holder 120, 220 by providing a larger surface to contact regions of the insert pocket 125, 225. Increased stability may be particularly important to accommodate high-speed machining operations.

In various non-limiting embodiments, the slope of the substantially flat side regions 112, 212 of the mounting region 110, 210 relative to the longitudinal axis of the cutting tool insert 100, 200 can be at an angle in a range of 0 to 15 degrees, such as, for example, 0 to 12 degrees, 0 to 10 degrees, 6 to 15 degrees, 7 to 15 degrees, 7 to 11 degrees, or 8 to 10 degrees. For example, the slope of the substantially flat side regions 110, 210 can be at an angle of at least 5 degrees, such as, for example, at least 7 degrees, at least 8 degrees, at least 9 degrees, at least 10 degrees, or at least 11 degrees. In various non-limiting embodiments, the slope of the substantially flat side regions 112, 212 of the mounting region 110, 210 may be no greater than 14 degrees such as, for example, no greater than 13 degrees, no greater than 12 degrees, no greater than 11 degrees, no greater than 10 degrees, or no greater than 9 degrees. In certain embodiments, the slope of the substantially flat side regions 112, 212 of the mounting region 110, 210 can be in a range of 5 degrees to 15 degrees, such as, for example, 7 degrees to 13 degrees, or 9 degrees to 11 degrees. In various embodiments, the slope of the substantially flat side regions 110, 210 is about 11 degrees,

Referring now to FIGS. 6A-6B, the six-sided cutting tool insert 100 can be removably attached to a tool holder 120. As discussed above, a “tool holder” as used herein refers to any machine tool or cutting insert holder used in machining operations. Such machine tools include, but are not limited to, cutting tools in which the tool rotates during machining operations (e.g., end mills, face mills, slotting tools, boring tools) or tools in which the tool is not rotated during machining operations (e.g., lathe tools).

Again referring to FIGS. 6A-6B, with respect to six-sided cutting tool insert 100, the tool holder 120 may comprise a nest member 128 including an insert pocket 125 in which the cutting tool insert 100 is secured. The insert pocket 125 embodiment illustrated in the accompanying figures includes projections 129 on an upper surface 131 of the nest member 128. With reference to FIG. 6B, the cutting tool insert 100 can be positioned properly in place (typically by hand) as follows: first, the nest member 128 is secured to the tool holder 120 by fastener 132; second, the flat surface of the second end 104 of the cutting tool insert 100 is positioned to rest against the top surface 131 of the nest member 128, which forms the floor of the insert pocket 125; third, two flat side regions 112 of the mounting region 110 of the cutting tool insert 100 are positioned to rest within an included angled V-shaped pocket defined by the projections 129. The cutting tool insert 100 is disposed on the upper surface 131 (which forms the floor of the insert pocket 125) so that the projections 129 abut two immediately adjacent substantially flat side regions 112 of the mounting region and thereby inhibit rotation of the cutting tool insert 100 relative to the tool holder 120 when the nest member 128 and cutting tool insert 100 are secured to the tool holder 120. The projections 129 of the insert pocket 125 can be positioned so that rotating the cutting tool insert 100 and disposing it in contact with the projections 129 will position the cutting tool insert 100 in any one of the six indexing position shown in FIG. 6A when the nest member 128 and its insert pocket 125 are secured to the tool holder 120. In various non-limiting embodiments, the insert pocket 125 can be configured to limit the height of the projections 129 so that the clearance region 114 of the cutting tool insert 100 does not contact the tool holder 120. The insert pocket 125 of the nest member 128 can be configured to accommodate more than one cutting tool insert having elements of a design in accordance with the present invention, such that different cutting tool inserts can be used interchangeably with the same nest member 128 and corresponding insert pocket 125.

The cutting tool insert 100 can be secured to the insert pocket 125 and to the tool holder 120. As illustrated in FIG. 6B, the cutting tool insert 100 can be removably attached using a top clamp 126, which applies a compressive force to the cutting tool insert 100 to secure the cutting tool insert 100 within the insert pocket 125 and in contact with the projections 129. A top clamp fastener 130 may secure the top clamp 126 to the tool holder 120. As the top clamp fastener 130 is tightened, additional compressive force can be exerted by the top clamp 126 on the cutting tool insert 100, further securing the cutting tool insert 100 to the top surface 131 of the nest member forming the floor of the insert pocket 125 and to the tool holder 120.

With reference to FIG. 8A-8B, with respect to the two-sided cutting tool insert 200, the tool holder 220 may comprise a nest member 228 including an insert pocket 225 in which the cutting tool insert 200 is secured. The insert pocket 225 embodiment illustrated in the accompanying figures includes projections 229 on an upper surface 231 of the nest member 228. With reference to FIG. 8B, the cutting tool insert 200 can be positioned properly in place (typically by hand) as follows: first, the nest member 228 is secured to the tool holder 220 by fastener 232; second, the flat surface of the second end 204 of the cutting tool insert 200 is positioned to rest against the top surface 231 of the nest member 228, which forms the floor of the insert pocket 225; third, two flat side regions 212 of the mounting region 210 of the cutting tool insert 200 are positioned to rest within an included angled V-shaped pocket defined by the projections 229. The cutting tool insert 200 is disposed on the upper surface 231 (which forms the floor of the insert pocket 225) so that the projections 229 abut two immediately adjacent substantially flat side regions 212 of the mounting region and inhibit rotation of the cutting tool insert 200 relative to the tool holder 220 when the nest member 228 and the cutting tool insert 200 are secured to the tool holder 220. The projections 229 of the insert pocket 225 can be positioned so that rotating the cutting tool insert 200 and disposing it in contact with the projections 229 will position the cutting tool insert 200 in one of the two indexing positions shown in FIG. 8A when the nest member 225 and its insert pocket 225 are secured to the tool holder 220. In various non-limiting embodiments, the insert pocket 225 can be configured to limit the height of the projections 229 so that the clearance region 214 of the cutting tool insert 200 does not contact the tool holder 220. The insert pocket 225 of the nest member 228 can be configured to accommodate more than one cutting tool insert having elements of a design in accordance with the present invention, such that different cutting tool inserts can be used interchangeably with the same nest member 228 and corresponding insert pocket 225.

The cutting tool insert 200 can be secured to the insert pocket 225 and to the tool holder 220. As illustrated in FIG. 8B, in various non-limiting embodiments, the cutting tool insert 200 can be removably attached using a top clamp 226, which applies a compressive force to the cutting tool insert 200 to secure the cutting tool insert 200 within the insert pocket 225 and in contact with the projections 229. A top clamp fastener 230 may secure the top clamp 226 to the tool holder 220. As the top clamp fastener 230 is tightened, additional compressive force can be exerted by the top clamp 226 on the cutting tool insert 200, further securing the cutting tool insert 200 to the top surface 231 of the nest member forming the floor of the insert pocket 225 and to the tool holder 220.

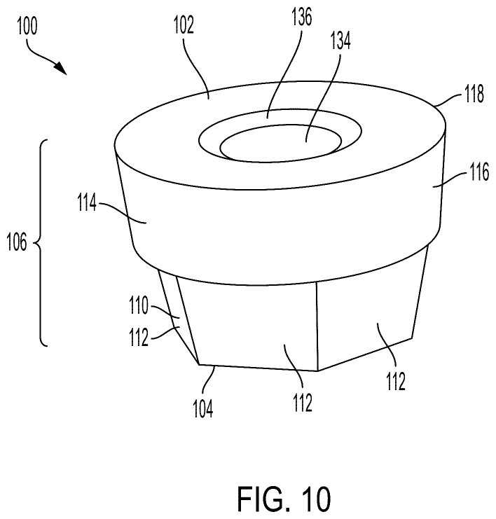

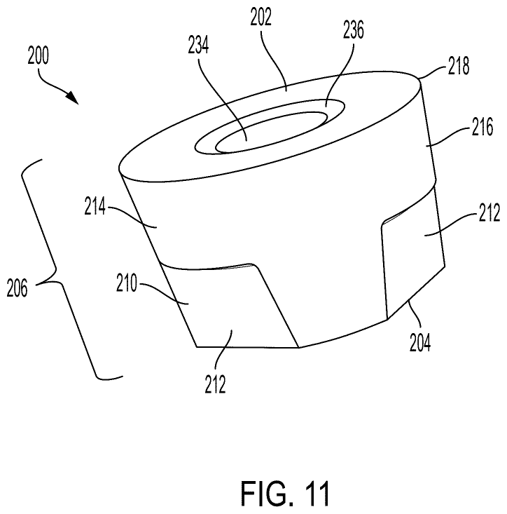

Other, alternative, arrangements may be provided to secure the cutting tool insert 100, 200 to the insert pocket 125, 225 and to the tool holder 120, 220. For example, in certain non-limiting embodiments illustrated in FIGS. 10 and 11, cutting tool inserts 100, 200 may comprise a bore 134, 234 extending through the cutting tool insert 100, 200 in a direction of the longitudinal axis and from the first surface 102, 202 to the second surface 104, 204. A threaded fastener may be disposed through the bore 134, 234 and, for example, into a threaded hole in the top surface 131, 231, of the insert pocket 125, 225, thereby securing the cutting tool insert to the insert pocket 125, 225 of the nest member 128, 228, which in turn is secured to the tool holder 120, 220 by fastener 132, 232. In certain embodiments, the periphery of the bore 134, 234 on the first end 102, 202 may include a chamfer 136, 236. The bore may be configured to receive a threaded screw 138, 238 securing the cutting tool insert 100, 200 to the insert pocket 125, 225 of the tool holder 120, 220. The chamfer 126, 236 may allow the cutting tool insert 100, 200 to more precisely seat in a desired position on the insert pocket 125, 225.

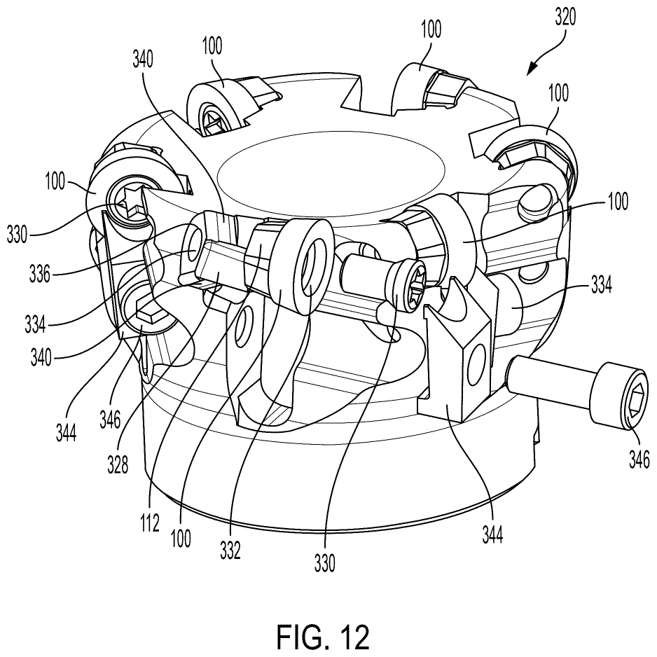

FIG. 12 illustrates a non-limiting embodiment of a face milling cutter 320 comprising six insert pockets 328 configured to receive cutting tool inserts according to the present disclosure. Each insert pocket 328 is milled directly into the body of the milling cutter 320 and is not formed on a removable nest or other removable member. Each cutting tool insert 100 is secured within an insert pocket 328 by a threaded screw 330 disposed in a through-hole 332 in the cutting tool insert 100 and secured in a threaded bore 334 in a base surface 336 of the insert pocket 328. Each insert pocket 328 includes two flat side wall regions 340 angled from one another. When a cutting tool insert 100 is disposed in an insert pocket 328, two non-adjacent flat side regions 112 of the mounting region 110 of the cutting tool insert 100 contact the side wall regions 340 and stably position the cutting tool insert 100 relative to the insert pocket 328 and the milling cutter 320 in a selected one of the six possible indexing orientations. A clamp member 344 secured on the milling cutter 320 by a threaded fastener 346 securely clamps the cutting tool insert 100 against the base surface 336 of the of the insert pocket 328 to inhibit movement of the insert 100 during a machining operation.

Again referring to FIG. 12, each cutting tool insert 100 can be repositioned in a different indexing orientation by unsecuring clamp member 344, loosening or removing threaded screw 330, rotating the cutting tool insert 100 relative to the insert pocket 328, and re-securing the cutting tool insert 100 in the insert pocket 328 via the threaded screw 330 and the clamp member 344 with two non-adjacent flat side regions 112 of the mounting region 110 of the cutting tool insert 100 abutting the two flat side wall regions 340 of the insert pocket 328. The function of the side wall regions 340 to accurately and stably position the cutting tool insert 100 in one of the possible indexing orientations within the insert pocket 328 corresponds to that of the projections 129, 229 of insert pockets 128, 228 of tool holders 120 and 220, respectively.

Although face milling cutter 320 has been described in connection with six-sided cutting tool insert 100, it will be understood that the insert pockets 328 of the face milling cutter 320 also may accommodate two-sided cutting tool insert 200 or other cutting tool insert geometries as described herein.

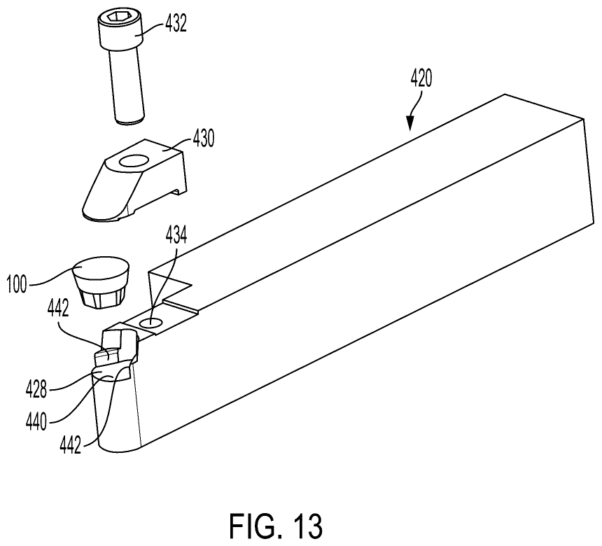

FIG. 13 illustrates a non-limiting embodiment of a tool holder 420 according to the present disclosure comprising a single insert pocket 428 configured to receive a cutting tool insert 100 according to the present disclosure. The insert pocket 428 is milled directly into the body of the tool holder 420 and is not formed on a removable nest or other removable member. The insert pocket 428 includes two flat side wall regions 442 angled from one another. When cutting tool insert 100 is disposed in the insert pocket 428, two non-adjacent flat side regions 112 of the mounting region 110 of the cutting tool insert 100 contact the side wall regions 440 and stably position the cutting tool insert 100 relative to the insert pocket 428 and the tool holder 420 in a selected one of the six possible indexing orientations. Cutting tool insert 100 is secured within the insert pocket 428 by a clamp member 430 that is secured to the tool holder by a threaded screw 432 disposed through a bore in the clamp member 430 and threadedly secured in a threaded bore 434 in the tool holder 420. The cutting tool insert 100 illustrated in FIG. 13 does not include a through-hole. However, it will be understood that in an alternative embodiment the cutting tool insert 100 may include a through-hole and be at least partially secured by a threaded fastener disposed through the through-hole and secured in a threaded bore in the base surface 440 of the insert pocket 428.

Again referring to FIG. 13, cutting tool insert 100 can be repositioned in a different indexing orientation by unsecuring clamp member 430, rotating the cutting tool insert 100 relative to the insert pocket 428, and re-securing the cutting tool insert 100 in the insert pocket 428 with two non-adjacent flat side regions 112 of the mounting region 110 of the cutting tool insert 100 abutting the two flat side wall regions 442 of the insert pocket 428. The function of the side wall regions 442 to accurately and stably position the cutting tool insert 100 in one of the possible indexing orientations within the insert pocket 428 corresponds to that of the projections 129, 229 of insert pockets 128, 228 of tool holders 120 and 220, respectively.

Although tool holder 420 has been described in connection with six-sided cutting tool insert 100, it will be understood that the insert pocket 428 of the tool holder 420 also may accommodate two-sided cutting tool insert 200 or other cutting tool insert geometries as described herein.

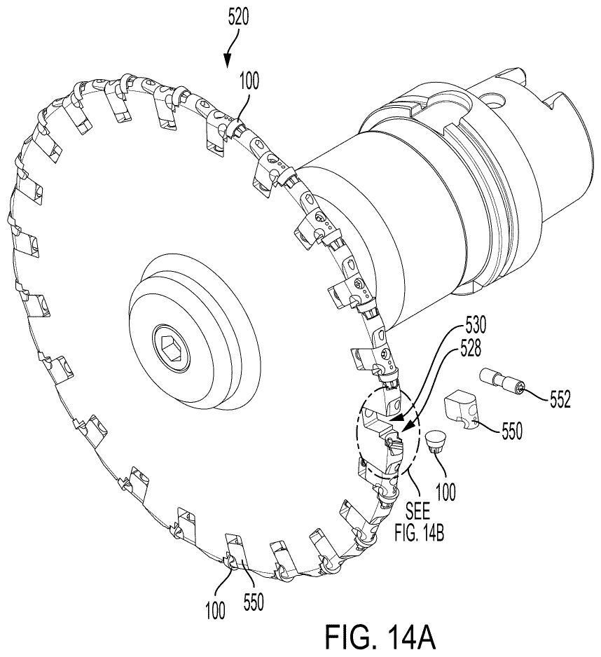

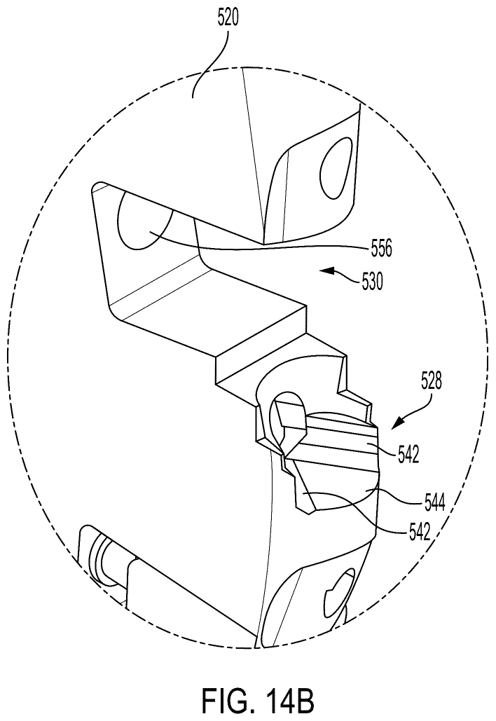

FIG. 14A illustrates a non-limiting embodiment of a blisk (i.e., bladed disk) milling cutter 520 according to the present disclosure comprising multiple insert pockets 428 configured to receive cutting tool inserts 100 according to the present disclosure. FIG. 14B illustrates a region of the blisk milling cutter 520 including one of 22 identical insert pockets 528 and wedge member recesses 530 evenly spaced about the periphery of blisk milling cutter 520. The insert pockets 528 is milled directly into the body of the blisk milling cutter 520 and are not formed on removable nests or other removable members. As best shown in FIG. 14B, each insert pocket 528 includes a base surface 544 and two flat side wall regions 542 angled from one another. When a cutting tool insert 100 is disposed in an insert pocket 548, a bottom surface 104 of the cutting tool insert 100 contacts the base surface 544, and two non-adjacent flat side regions 112 of the mounting region 110 of the cutting tool insert 100 contact the side wall regions 540 and stably position the cutting tool insert 100 relative to the insert pocket 548 and the milling cutter 520 in a selected one of the six possible indexing orientations of the cutting tool insert 100. Each cutting tool insert 100 is secured within an insert pocket 528 by a wedge member 550 that is secured to the milling cutter 520 by disposing a portion of the wedge member 550 in a wedge member recess 530 adjacent to the insert pocket 528 by Torx fastener 552 through a bore in the wedge member 550 and into a clamp fastener bore 556 in the wedge member recess 530. The cutting tool insert 100 illustrated in FIG. 14A does not include a through-hole. However, it will be understood that in an alternative embodiment the cutting tool insert 100 may include a through-hole and be at least partially secured by a threaded fastener disposed through the through-hole and secured in a threaded bore in the base surface 544 of the insert pocket 528.

Again referring to FIGS. 14A and 14B, cutting tool insert 100 can be repositioned in a different indexing orientation by loosening wedge member 550, rotating the cutting tool insert 100 relative to the insert pocket 528, and re-securing the cutting tool insert 100 in the insert pocket 528 with two non-adjacent flat side regions 112 of the mounting region 110 of the cutting tool insert 100 abutting the two flat side wall regions 542 of the insert pocket 528. The function of the side wall regions 542 to accurately and stably position the cutting tool insert 100 in one of the possible indexing orientations within an insert pocket 528 corresponds to that of the projections 129, 229 of insert pockets 128, 228 of tool holders 120 and 220, respectively.

Although blisk milling cutter 520 has been described in connection with six-sided cutting tool insert 100, it will be understood that the insert pocket 528 of the tool holder 520 also may accommodate two-sided cutting tool insert 200 or other cutting tool insert geometries as described herein.

Although described herein with reference to cutting tool insert embodiments with two or six indexing orientations, the present disclosure contemplates that embodiments of a cutting tool insert according to the present disclosure can comprise other numbers of indexing orientations, including, but not limited to, three, four, five, seven, eight, nine, ten, eleven, or twelve indexing orientations. For example, by varying the number and arrangement of substantially flat side regions included on the mounting region of cutting tool insert 200, the number of indexing orientations can be varied from the six provided with cutting tool insert 200. Such variation from six indexing orientations would also correspondingly reduce or increase from six the number of individual cutting edge regions on the resulting cutting tool insert.

Cutting tool inserts according to the present disclosure may have a top surface of any suitable diameter and other dimensions as desired.

Cutting tool inserts according to the present disclosure can comprise any material suitable for use in cutting tool inserts. Such materials include, for example, cemented carbides, cermets, cubic boron nitride, and ceramics. In certain embodiments, cutting tool inserts according to the present disclosure comprise a cemented carbide material composed of, for example, a discontinuous phase of tungsten carbide particles in a continuous cobalt matrix. Cemented carbide materials provide a balance of hardness and toughness, which may allow the inserts to be used in a variety of machining applications. In certain embodiments, cutting tool inserts according to the present disclosure comprise a ceramic material selected from, for example, aluminum oxide and silicon nitride. Ceramic materials provide relatively high hardness and heat-resistance, which may be particularly beneficial for high-speed machining of hard materials. In certain embodiments, cutting tool inserts according to the present disclosure may be coated and/or include silicon carbide or other types of whiskers to increase toughness and/or strength. In certain embodiments, cutting tool inserts according to the present disclosure are produced form any of the WG-300®, WG-600@, and WG-700™ whisker-reinforced ceramic materials available from Greenleaf Corporation, Saegertown, Pennsylvania USA.

In various non-limiting embodiments, cutting tool inserts according to the present disclosure may comprise cutting edge regions including a chip breaker geometry. A chip breaker geometry may include, but is not limited to, a groove, a flute, or other contour that advantageously affects the production and flow of machining chips during machining operations. Providing a cutting edge with one or more chip breaker geometry features can reduce the risk of premature wear and/or damage to the cutting tool insert resulting from jamming or interference with machining chips.

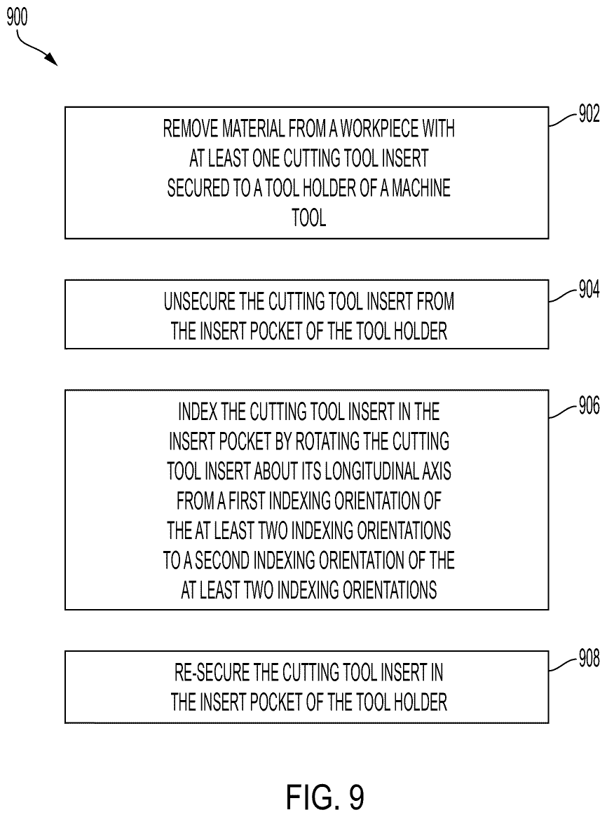

FIG. 9 illustrates an embodiment of a machining method according to the present disclosure. At step 902, the method 900 comprises removing material from a workpiece using at least one cutting tool insert according to the present disclosure secured to a tool holder. At step 904, method 900 optionally comprises unsecuring the cutting tool insert from the insert pocket of the tool holder. At step 906, the method 900 optionally further comprises indexing the cutting tool insert in the insert pocket by rotating the cutting tool insert about its longitudinal axis or otherwise re-orienting the cutting tool insert from a first indexing orientation of the cutting insert's at least two indexing orientations to a second indexing orientation. As step 908, the method 900 optionally further comprises re-securing the cutting tool insert in the insert pocket of the tool holder.

Clause 1: A cutting tool insert including: a first end including a circular periphery defining at least two arcuate cutting edge regions; a second end; and an elongate portion extending from the first end to the second end along a longitudinal axis of the cutting tool insert. The elongate portion includes: a mounting region extending along a first portion of the longitudinal axis to the second end, the mounting region including a plurality of substantially flat side regions capable to be received in an insert pocket of a tool holder and defining at least two indexing orientations of the cutting tool insert as installed in the insert pocket of the tool holder; and an inverted frustoconical shaped clearance region extending along a second portion of the longitudinal axis to the circular periphery of the first end, wherein each arcuate cutting edge region of the circular periphery is associated with one of the at least two indexing orientations.

Clause 2: The cutting tool insert of Clause 1, wherein the plurality of substantially flat side regions defines six indexing orientations of the cutting tool insert as installed in the insert pocket of the tool holder.

Clause 3: The cutting tool insert of Clause 1, wherein the plurality of substantially flat side regions consists of six substantially flat sides.

Clause 4: The cutting tool insert of Clause 3, wherein the six substantially flat sides are distributed around the longitudinal axis to define a hexagonal transverse cross-section of the mounting region.

Clause 5: The cutting tool insert of Clause 1, wherein the plurality of substantially flat side regions defines two indexing orientations of the cutting tool insert as installed in the insert pocket of the tool holder.

Clause 6: The cutting tool insert of Clause 5, wherein the plurality of substantially flat side regions consists of four substantially flat sides.

Clause 7: The cutting tool insert of Clause 6, wherein: the mounting region further includes a first curved side region and a second curved side region; a first substantially flat side region of the plurality of substantially flat side regions is adjacent to a second substantially flat side region of the plurality of substantially flat side regions; a third substantially flat side region of the plurality of substantially side regions is adjacent to a fourth substantially flat side region of the plurality of substantially side regions; the first curved side region is intermediate the first and the third substantially flat side regions; and the second curved side region is intermediate the second and the fourth substantially flat side regions.

Clause 8: The cutting tool insert of any of Clauses 1-7, wherein the first end includes a planar surface bounded by the circular periphery.

Clause 9: The cutting tool insert of any of Clauses 1-8, wherein a surface of the inverted frustoconical shaped clearance region defines a side clearance angle in a range of 5 to 25 degrees relative to the longitudinal axis of the cutting tool insert.

Clause 10: The cutting tool insert of any of Clauses 1-9, wherein a surface of the inverted frustoconical shaped clearance region defines a side clearance angle in a range of 7 to 11 degrees relative to the longitudinal axis of the cutting tool insert.

Clause 11: The cutting tool insert of any of Clauses 1-10, wherein a surface of each of the substantially flat side regions of the plurality of substantially flat side regions is at an angle of about 0 degrees up to about 15 degrees relative to the longitudinal axis of the cutting tool insert.

Clause 12: A machining method including removing material from a workpiece with at least one cutting tool insert secured to a tool holder of a machine tool, wherein the cutting tool insert comprises: a first end including a circular periphery defining at least two arcuate cutting edge regions; a second end; and an elongate portion extending from the first end to the second end along a longitudinal axis of the cutting tool insert. The elongate portion includes: a mounting region extending along a first portion of the longitudinal axis to the second end, the mounting region including a plurality of substantially flat side regions capable to be received in an insert pocket of a tool holder and defining at least two indexing orientations of the cutting tool insert as installed in the insert pocket of the tool holder; and an inverted frustoconical shaped clearance region extending along a second portion of the longitudinal axis to the circular periphery of the first end, wherein each arcuate cutting edge region of the circular periphery is associated with one of the at least two indexing orientations.

Clause 13: The machining method of Clause 12, wherein the plurality of substantially flat side regions of the cutting tool insert defines six indexing orientations of the cutting tool insert as installed in the insert pocket of the tool holder.

Clause 14: The machining method of Clause 12, wherein the plurality of substantially flat side regions of the cutting tool insert consists of six substantially flat sides.

Clause 15: The machining method of Clause 14, wherein the six substantially flat sides of the cutting tool insert are distributed around the longitudinal axis to define a hexagonal transverse cross-section of the mounting region.

Clause 16: The machining method of Clause 12, wherein the plurality of substantially flat side regions of the cutting tool insert defines two indexing orientations of the cutting tool insert as installed in the insert pocket of the tool holder.

Clause 17: The machining method of Clause 16, wherein the plurality of substantially flat side regions of the cutting tool insert consists of four substantially flat sides.

Clause 18: The machining method of Clause 17, wherein: the mounting region further includes a first curved side region and a second curved side region; a first substantially flat side region of the plurality of substantially flat side regions is adjacent to a second substantially flat side region of the plurality of substantially flat side regions; a third substantially flat side region of the plurality of substantially side regions is adjacent to a fourth substantially flat side region of the plurality of substantially side regions; the first curved side region is intermediate the first and the third substantially flat side regions; and the second curved side region is intermediate the second and the fourth substantially flat side regions.

Clause 19: The machining method of any of Clauses 12-18, wherein the first end of the cutting tool insert includes a planar surface bounded by the circular periphery.

Clause 20: The machining method of any of Clauses 12-19, wherein a surface of the inverted frustoconical shaped clearance region of the cutting tool insert defines a side clearance angle in a range of 5 to 25 degrees relative to the longitudinal axis of the cutting tool insert.

Clause 21: The machining method of any of Clauses 12-19, wherein a surface of the inverted frustoconical shaped clearance region of the cutting tool insert defines a side clearance angle in a range of 7 to 11 degrees relative to the longitudinal axis of the cutting tool insert.

Clause 22: The machining method of any of Clauses 12-21, wherein a surface of each of the substantially flat side regions of the plurality of substantially flat side regions of the cutting tool insert is angled at an angle in a range of about 0 degrees up to about 15 degrees relative to the longitudinal axis of the cutting tool insert.

Clause 23: The machining method of any of Clauses 12-22, further including: unsecuring the cutting tool insert from the insert pocket of the tool holder; indexing the cutting tool insert in the insert pocket by rotating the cutting tool insert about its longitudinal axis from a first indexing orientation of the at least two indexing orientations to a second indexing orientation of the at least two indexing orientations; and re-securing the cutting tool insert in the insert pocket of the tool holder.

Clause 24: The machining method of Clause 23, wherein the second indexing orientation positions a different arcuate cutting edge region of the at least two arcuate cutting edge regions for engagement with a workpiece.

Clause 25: A tool holder including at least one replaceable cutting tool insert including: a first end including a circular periphery defining at least two arcuate cutting edge regions; a second end; and an elongate portion extending from the first end to the second end along a longitudinal axis of the cutting tool insert. The elongate portion includes: a mounting region extending along a first portion of the longitudinal axis to the second end, the mounting region including a plurality of substantially flat side regions capable to be received in an insert pocket of a tool holder and defining at least two indexing orientations of the cutting tool insert as installed in the insert pocket of the tool holder; and an inverted frustoconical shaped clearance region extending along a second portion of the longitudinal axis to the circular periphery of the first end, wherein each arcuate cutting edge region of the circular periphery is associated with one of the at least two indexing orientations.

Clause 26: The tool holder of Clause 25, wherein the plurality of substantially flat side regions of the cutting tool insert defines six indexing orientations of the cutting tool insert as installed in the insert pocket of the tool holder.

Clause 27: The tool holder of Clause 25, wherein the plurality of substantially flat side regions of the cutting tool insert consists of six substantially flat sides.

Clause 28: The tool holder of Clause 27, wherein the six substantially flat sides of the cutting tool insert are distributed around the longitudinal axis to define a hexagonal transverse cross-section of the mounting region.

Clause 29: The tool holder of Clause 25, wherein the plurality of substantially flat side regions of the cutting tool insert defines two indexing orientations of the cutting tool insert as installed in the insert pocket of the tool holder.

Clause 30: The tool holder of Clause 29, wherein the plurality of substantially flat side regions of the cutting tool insert consists of four substantially flat sides.

Clause 31: The tool holder of Clause 30, wherein: the mounting region further includes a first curved side region and a second curved side region; a first substantially flat side region of the plurality of substantially flat side regions is adjacent to a second substantially flat side region of the plurality of substantially flat side regions; a third substantially flat side region of the plurality of substantially side regions is adjacent to a fourth substantially flat side region of the plurality of substantially side regions; the first curved side region is intermediate the first and the third substantially flat side regions; and the second curved side region is intermediate the second and the fourth substantially flat side regions.

Clause 32: The tool holder of any of Clauses 25-31, wherein the first end of the cutting tool insert includes a planar surface bounded by the circular periphery.

Clause 33: The tool holder of any of Clauses 25-32, wherein a surface of the inverted frustoconical shaped clearance region of the cutting tool insert defines a side clearance angle in a range of 5 to 25 degrees relative to the longitudinal axis of the cutting tool insert.

Clause 34: The tool holder of any of Clauses 25-33, wherein a surface of the inverted frustoconical shaped clearance region of the cutting tool insert defines a side clearance angle in a range of 7 to 11 degrees relative to the longitudinal axis of the cutting tool insert.

Clause 35: The tool holder of any of Clauses 25-34, wherein a surface of each of the substantially flat side regions of the plurality of substantially flat side regions of the cutting tool insert is at an angle of about 0 degrees up to about 15 degrees relative to the longitudinal axis of the cutting tool insert.

Clause 36: The tool holder of any of Clauses 25-35, wherein the tool holder is selected from a face mill, an end mill, a turning (lathe) tool, a boring tool, a grooving tool, a parting tool, a blisk milling cutter, a slotting cutter, and a threading tool.

Having thus described several aspects and embodiments of the technology of this application, it is to be appreciated that various alterations, modifications, and improvements will readily occur to those of ordinary skill in the art. Such alterations, modifications, and improvements are intended to be within the scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combinations of two or more features, systems, articles, materials, and/or methods described herein, if such features, systems, articles, materials, and/or methods are not mutually inconsistent, are included within the scope of the present disclosure.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

1. A cutting tool insert comprising:
a first end including a circular periphery, the circular periphery defining at least two arcuate cutting edge regions;
a second end; and
an elongate portion extending from the first end to the second end along a longitudinal axis of the cutting tool insert, the elongate portion comprising:
a mounting region extending along a first portion of the longitudinal axis to the second end, the mounting region comprising a plurality of substantially flat side regions capable to be received in an insert pocket of a tool holder and defining a corresponding plurality of discrete indexing orientations of the cutting tool insert as installed in the insert pocket of the tool holder;
wherein the mounting region extends along at least 10% of an overall longitudinal axial length of the cutting tool insert, and wherein the substantially flat side regions are circumferentially distributed about the longitudinal axis such that each indexing orientation is defined by a unique pair of substantially flat side regions; and
an inverted frustoconical shaped clearance region extending along a second portion of the longitudinal axis to the circular periphery of the first end, wherein each arcuate cutting edge region of the circular periphery is associated with exactly one of the plurality of indexing orientations, such that when the cutting tool insert is installed in a given indexing orientation, only the arcuate cutting edge region corresponding to that indexing orientation is positioned for engagement with a workpiece.

2. The cutting tool insert of claim 1, wherein the plurality of substantially flat side regions defines six discrete indexing orientations of the cutting tool insert as installed in the insert pocket of the tool holder.

3. The cutting tool insert of claim 2, wherein the plurality of substantially flat side regions consists of six substantially flat side regions.

4. The cutting tool insert of claim 3, wherein the six substantially flat side regions are distributed around the longitudinal axis to define a hexagonal transverse cross-section of the mounting region.

5. The cutting tool insert of claim 1, wherein the plurality of substantially flat side regions defines two discrete indexing orientations of the cutting tool insert as installed in the insert pocket of the tool holder.

6. The cutting tool insert of claim 5, wherein the plurality of substantially flat side regions consists of four substantially flat side regions.

7. The cutting tool insert of claim 6, wherein:
the mounting region further comprises a first curved side region and a second curved side region;
a first substantially flat side region of the plurality of substantially flat side regions is adjacent to a second substantially flat side region of the plurality of substantially flat side regions;
a third substantially flat side region of the plurality of substantially side regions is adjacent to a fourth substantially flat side region of the plurality of substantially side regions;
the first curved side region is intermediate the first and the third substantially flat side regions; and
the second curved side region is intermediate the second and the fourth substantially flat side regions.

8. The cutting tool insert of claim 1, wherein the first end comprises a planar surface bounded by the circular periphery.

9. The cutting tool insert of claim 1, wherein a surface of the inverted frustoconical shaped clearance region defines a side clearance angle in a range of 5 to 25 degrees relative to the longitudinal axis of the cutting tool insert.

10. The cutting tool insert of claim 1, wherein a surface of the inverted frustoconical shaped clearance region defines a side clearance angle in a range of 7 to 11 degrees relative to the longitudinal axis of the cutting tool insert.

11. The cutting tool insert of claim 1, wherein a surface of each of the substantially flat side regions of the plurality of substantially flat side regions is angled at 0 up to about 15 degrees relative to the longitudinal axis of the cutting tool insert.

12. A machining method comprising removing material from a workpiece with at least one cutting tool insert secured to a tool holder of a machine tool, wherein the cutting tool insert comprises:
a first end including a circular periphery, the circular periphery defining at least two arcuate cutting edge regions;
a second end; and
an elongate portion extending from the first end to the second end along a longitudinal axis of the cutting tool insert, the elongate portion comprising:
a mounting region extending along a first portion of the longitudinal axis to the second end, the mounting region comprising a plurality of substantially flat side regions capable to be received in an insert pocket of a tool holder and defining a corresponding plurality of discrete indexing orientations of the cutting tool insert as installed in the insert pocket of the tool holder;
wherein the mounting region extends along at least 10% of an overall longitudinal axial length of the cutting tool insert, and wherein the substantially flat side regions are circumferentially distributed about the longitudinal axis such that each indexing orientation is defined by a unique pair of substantially flat side regions; and
an inverted frustoconical shaped clearance region extending along a second portion of the longitudinal axis to the circular periphery of the first end, wherein each arcuate cutting edge region of the circular periphery is associated with exactly one of the plurality of indexing orientations, such that when the cutting tool insert is installed in a given indexing orientation, only the arcuate cutting edge region corresponding to that indexing orientation is positioned for engagement with the workpiece.

13.-22. (canceled)

23. The machining method of claim 12, further comprising:
unsecuring the cutting tool insert from the insert pocket of the tool holder;
indexing the cutting tool insert in the insert pocket by rotating the cutting tool insert about its longitudinal axis from a first indexing orientation of the plurality of indexing orientations to a second indexing orientation of the plurality of indexing orientations; and
re-securing the cutting tool insert in the insert pocket of the tool holder.

24. The machining method of claim 23 wherein the second indexing orientation positions a different arcuate cutting edge region of the at least two arcuate cutting edge regions for engagement with a workpiece.

25. A tool holder including at least one replaceable cutting tool insert, the cutting tool insert comprising:
a first end including a circular periphery, the circular periphery defining at least two arcuate cutting edge regions;
a second end; and
an elongate portion extending from the first end to the second end along a longitudinal axis of the cutting tool insert, the elongate portion comprising:
a mounting region extending along a first portion of the longitudinal axis to the second end, the mounting region comprising a plurality of substantially flat side regions capable to be received in an insert pocket of a tool holder and defining a corresponding plurality of discrete indexing orientations of the cutting tool insert as installed in the insert pocket of the tool holder;
wherein the mounting region extends along at least 10% of an overall longitudinal axial length of the cutting tool insert, and wherein the substantially flat side regions are circumferentially distributed about the longitudinal axis such that each indexing orientation is defined by a unique pair of substantially flat side regions; and
an inverted frustoconical shaped clearance region extending along a second portion of the longitudinal axis to the circular periphery of the first end, wherein each arcuate cutting edge region of the circular periphery is associated with exactly one of the plurality of indexing orientations, such that when the cutting tool insert is installed in a given indexing orientation, only the arcuate cutting edge region corresponding to that indexing orientation is positioned for engagement with a workpiece.

26. The tool holder of claim 25, wherein the plurality of substantially flat side regions of the cutting tool insert defines six discrete indexing orientations of the cutting tool insert as installed in the insert pocket of the tool holder.

27. The tool holder of claim 25, wherein the plurality of substantially flat side regions of the cutting tool insert consists of six substantially flat side regions.

28. The tool holder of claim 27, wherein the six substantially flat side regions of the cutting tool insert are distributed around the longitudinal axis to define a hexagonal transverse cross-section of the mounting region.

29. The tool holder of claim 25, wherein the plurality of substantially flat side regions of the cutting tool insert defines two discrete indexing orientations of the cutting tool insert as installed in the insert pocket of the tool holder.

30. The tool holder of claim 29, wherein the plurality of substantially flat side regions of the cutting tool insert consists of four substantially flat side regions.

31. The tool holder of claim 30, wherein:
the mounting region further comprises a first curved side region and a second curved side region;
a first substantially flat side region of the plurality of substantially flat side regions is adjacent to a second substantially flat side region of the plurality of substantially flat side regions;
a third substantially flat side region of the plurality of substantially side regions is adjacent to a fourth substantially flat side region of the plurality of substantially side regions;
the first curved side region is intermediate the first and the third substantially flat side regions; and
the second curved side region is intermediate the second and the fourth substantially flat side regions.

32. The tool holder of claim 25, wherein the first end of the cutting tool insert includes a planar surface bounded by the circular periphery.

33. The tool holder of claim 25, wherein a surface of the inverted frustoconical shaped clearance region of the cutting tool insert defines a side clearance angle in a range of 5 to 25 degrees relative to the longitudinal axis of the cutting tool insert.

34. The tool holder of claim 25, wherein a surface of the inverted frustoconical shaped clearance region of the cutting tool insert defines a side clearance angle in a range of 7 to 11 degrees relative to the longitudinal axis of the cutting tool insert.

35. The tool holder of claim 25, wherein a surface of each of the substantially flat side regions of the plurality of substantially flat side regions of the cutting tool insert is at an angle of about 0 degrees up to about 15 degrees relative to the longitudinal axis of the cutting tool insert.

36. The tool holder of claim 25, wherein the tool holder is selected from a face mill, an end mill, a turning (lathe) tool, a boring tool, a grooving tool, a parting tool, a blisk milling cutter, a slotting cutter, and a threading tool.
